(19) United States
(12) Patent Application Publication
(10) Pub. No.: US 2019/0071071 A1
(43) Pub. Date: Mar. 7, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Hiroyuki Yamada, Wako-shi (JP); Makoto Katayama, Wako-shi (JP)

(21) Appl. No.: 16/115,592

(22) Filed: Aug. 29, 2018

(30) Foreign Application Priority Data
Sep. 5, 2017 (JP) 2017-170215

(51) Int. Cl. B60W 30/08; B60W 50/00; G01C 21/36; B60W 50/12

(52) U.S. Cl. CPC B60W 30/08; B60W 50/0097; G01C 21/36; B60W 2550/20; B60W 2540/18; B60W 2520/14; B60W 50/12

(57) ABSTRACT

A vehicle control device includes a recognition unit that recognizes another vehicle in a vicinity of a host vehicle, a turning determination unit that determines whether or not the host vehicle is turning in a specific situation, and an apparatus operation control unit that causes an on-vehicle apparatus to perform a predetermined operation in a case where the other vehicle recognized by the recognition unit is present within a predetermined area of the host vehicle, and the apparatus operation control unit inhibits the predetermined operation to be performed by the on-vehicle apparatus in a case where the turning determination unit determines that the host vehicle is turning in the specific situation.

### CROSS-REFERENCE TO RELATED APPLICATION

Priority is claimed on Japanese Patent Application No. 2017-170215, filed on Sep. 5, 2017, the content of which is incorporated herein by reference.

### BACKGROUND OF THE INVENTION

### Field of the Invention

The present invention relates to a vehicle control device, a vehicle control method, and a storage medium

### Description of Related Art

In recent years, techniques for preventing the output of an alarm or the fastening of occupants by seat belts in a case where it is erroneously determined that there is a likelihood of a rear collision of a host vehicle due to the presence of a fixed object, such as a guard rail located on the side of a road traveled on, have become known (for example, Japanese Examined Patent Application, First Publication No. 2002-234418).

### SUMMARY OF THE INVENTION

However, in the related art, a fixed object such as a wall located behind a host vehicle is prevented from being erroneously recognized as an object approaching the host vehicle at a curved road or an intersection, but erroneous recognition for prediction regarding whether or not a host vehicle will come into contact with a surrounding vehicle has not been considered. For this reason, an on-vehicle apparatus of the host vehicle sometimes operates erroneously.

Aspects of the present invention have been made in view of such circumstances, and an object of the present invention is to provide a vehicle control device, a vehicle control method, and a storage medium which are capable of appropriately inhibiting a predetermined operation of an on-vehicle apparatus.

A vehicle control device, a vehicle control method, and a storage medium according to the present invention adopt the following configurations.

(1) A vehicle control device according to an aspect of the present invention is a vehicle control device including a recognition unit that recognizes another vehicle in a vicinity of a host vehicle, a turning determination unit that determines whether or not the host vehicle is turning in a specific situation, and an apparatus operation control unit that causes an on-vehicle apparatus to perform a predetermined operation in a case where the other vehicle recognized by the recognition unit is present within a predetermined area of the host vehicle, in which the apparatus operation control unit inhibits the predetermined operation to be performed by the on-vehicle apparatus in a case where the turning determination unit determines that the host vehicle is turning in the specific situation.

(2) In the aspect of (1), the predetermined area may be an area set on a side behind the host vehicle.

(3) In the aspect of (1), the turning in the specific situation may be a right turn or a left turn in a situation where moving directions of the host vehicle intersect each other.

(4) In the aspect of (1), the vehicle control device may further include a road form determination unit that determines whether or not a form of a road on which the host vehicle is traveling includes a plurality of lanes, and a trajectory estimation unit that estimates a trajectory on which the host vehicle will travel and a trajectory on which the other vehicle will travel, in a case where the road form determination unit determines that a road onto which the host vehicle is turning includes a plurality of lanes, in which the apparatus operation control unit may cause the on-vehicle apparatus to perform the predetermined operation in a case where the road form determination unit determines that a road onto which the host vehicle is turning includes a plurality of lanes and a case where a lane on which the host vehicle will travel after turning, which is estimated by the trajectory estimation unit, and a lane on which the other vehicle will travel after turning are different from each other.

(5) In the aspect of (1), the predetermined operation to be performed by the on-vehicle apparatus may be inhibited in a case where it is determined that the host vehicle will turn right or turn left across a lane opposite to a lane on which the host vehicle is traveling.

(6) In the aspect of (1), the turning determination unit may determine whether or not the host vehicle is turning, on the basis of operation conditions of a directional indicator of the host vehicle.

(7) In the aspect of (1), the vehicle control device may further include an operation detection unit that detects a steering angle of a steering wheel for an occupant of the host vehicle to perform a steering operation, in which the turning determination unit may determine whether or not the host vehicle is turning, on the basis of whether or not the steering angle of the host vehicle which is detected by the operation detection unit is equal to or greater than a predetermined angle.

(8) In the aspect of (1), the vehicle control device may further include a yaw rate sensor that detects a yaw rate of the host vehicle, in which the turning determination unit may determine whether or not the host vehicle is turning, on the basis of whether or not the yaw rate of the host vehicle which is detected by the yaw rate sensor is equal to or greater than a predetermined value.

(9) In the aspect of (1), the turning determination unit may determine whether or not the host vehicle is turning, on the basis of whether or not a braking device of the host vehicle is operating.

(10) In the aspect of (1), the vehicle control device may further include a navigation device that outputs information regarding a route to a destination of the host vehicle, in which the turning determination unit may determine whether or not the host vehicle is turning, on the basis of a future route of the host vehicle which is obtained by the navigation device.

(11) A vehicle control method according to another aspect of the present invention is a vehicle control method which is executed by a computer mounted on a host vehicle and includes recognizing another vehicle in a vicinity of the host vehicle, determining whether or not the host vehicle is turning in a specific situation, causing an on-vehicle apparatus to perform a predetermined operation in a case where the other vehicle recognized is present within a predetermined area of the host vehicle, and inhibiting the predetermined operation to be performed by the on-vehicle apparatus in a case where it is determined that the host vehicle is turning in the specific situation.

(12) A storage medium according to still another aspect of the present invention is a non-transitory computer-readable storage medium storing a program causing an on-vehicle computer to recognize another vehicle in a vicinity of a host vehicle, determine whether or not the host vehicle is turning in a specific situation, cause an on-vehicle apparatus to perform a predetermined operation in a case where the other vehicle recognized is present within a predetermined area of the host vehicle, and inhibit the predetermined operation to be performed by the on-vehicle apparatus in a case where it is determined that the host vehicle is turning in the specific situation.

According to the aspects of (1) to (12) described above, it is possible to appropriately inhibit a predetermined operation of an on-vehicle apparatus.

### BRIEF DESCRIPTION OF THE DRAWINGS

FIG. 1 is a diagram showing a configuration of a vehicle control system according to an embodiment.

FIG. 2 is a diagram showing an example of the inside of a host vehicle in a case where the host vehicle is viewed from above.

FIG. 3 is a diagram showing an example of a door mirror.

FIG. 4 is a diagram showing a state where the relative position and posture of a host vehicle with respect to a traveling lane are recognized by a host vehicle position recognition unit.

FIG. 5 is a diagram showing an area on a side behind a host vehicle.

FIG. 6 is a diagram showing an example of a functional configuration of an apparatus operation control unit.

FIG. 7 is a diagram showing control details of driving support control in a situation where a surrounding vehicle is approaching from the side behind a host vehicle on an adjacent lane.

FIG. 8 is a diagram showing a traveling state of a host vehicle at time t2.

FIG. 9 is a diagram showing an example in which the likelihood of contact with a following vehicle in a case of turning right at an intersection is determined in a second situation.

FIG. 10 is a diagram showing an example in which the likelihood of contact with a following vehicle in a case of turning right at an intersection is determined in a third situation.

FIG. 11 is a flowchart showing an example of a flow of vehicle control processing according to the embodiment.

FIG. 12 is a flowchart showing an example of a detailed flow of the vehicle control processing according to the embodiment.

FIG. 13 is a diagram showing an example of a hardware configuration of a vehicle control device according to the embodiment.

### DETAILED DESCRIPTION OF THE INVENTION

Hereinafter, a vehicle control device, a vehicle control method, and a storage medium according to an embodiment of the present invention will be described with reference to the accompanying drawings. Hereinafter, a case where the rule of left-hand traffic is applied will be described, but the right and the left may be read reversely in a case where the rule of right-hand traffic is applied.

Overall Configuration

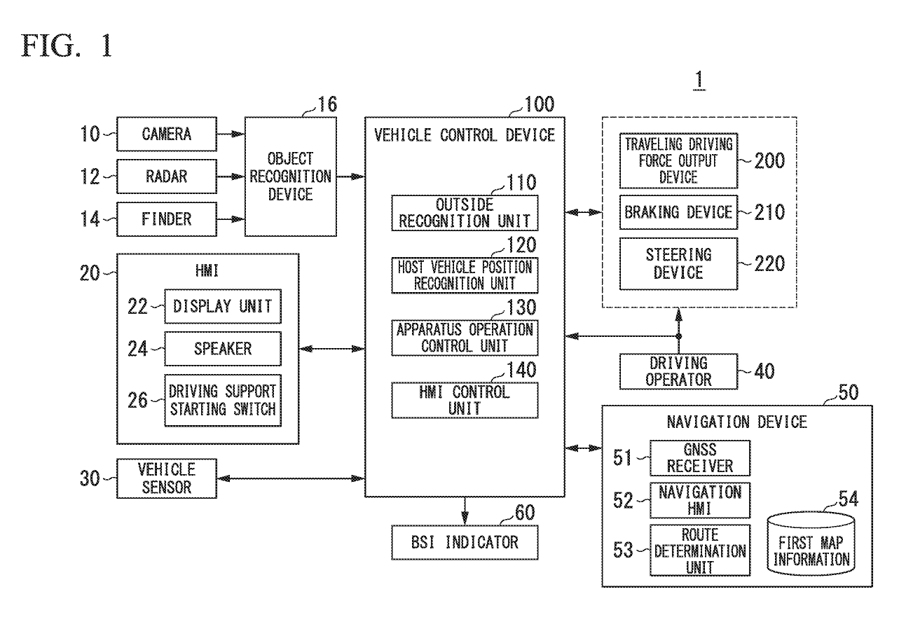

FIG. 1 is a diagram showing a configuration of a vehicle control system 1 according to an embodiment. A vehicle on which the vehicle control system 1 (hereinafter, referred to as a host vehicle M) is mounted is a vehicle such as a two-wheeled vehicle, a three-wheeled vehicle, or a four-wheeled vehicle, and a driving source thereof is an internal-combustion engine such as a diesel engine or a gasoline engine, a motor, or a combination thereof. The motor is operated using power generated by a power generator connected to the internal-combustion engine, or power discharged by a secondary battery or a fuel cell.

The vehicle control system 1 includes, for example, a camera 10, radars 12, finders 14, an object recognition device 16, a Human Machine Interface (HMI) 20, vehicle sensors 30, driving operators 40, a navigation device 50, a Blind Spot Information (BSI) indicator 60, a vehicle control device 100, a traveling driving force output device 200, a braking device 210, and a steering device 220. These devices and apparatuses are connected to each other through a multiple communication line such as a Controller Area Network (CAN) communication line, a serial communication line, or a wireless communication network. The configuration illustrated in FIG. 1 is just an example, and a portion of the configuration may be omitted, or other components may be added.

The camera 10 is a digital camera using a solid-state image sensing device such as a Charge Coupled Device (CCD) or a Complementary Metal Oxide Semiconductor (CMOS). One or a plurality of cameras 10 are attached at any location on the host vehicle M. For example, in a case where the side in front is imaged, the camera 10 is attached to an upper portion of a front windshield, the rear surface of a rearview mirror, or the like. For example, the camera 10 may repeatedly image the vicinity of the host vehicle M at regular intervals. The camera 10 may be a stereo camera.

The radar 12 radiates radio waves such as millimeter waves in the vicinity of the host vehicle M, and detects radio waves (reflected waves) reflected from an object to detect at least the position of (distance and direction to) the object. One or a plurality of radars 12 are attached to any location on the host vehicle M. The radar 12 may detect the position and speed of the object by a Frequency Modulated Continuous Wave (FM-CW) method.

The finder 14 is a Light Detection and Ranging or a Laser Imaging Detection and Ranging (LIDAR) finder that measures scattered light with respect to irradiation light and detects a distance to an object. One or a plurality of finders 14 are attached to any location on the host vehicle M.

The object recognition device 16 performs sensor fusion processing on detection results obtained by some or all of the camera 10, the radar 12, and the finder 14 to recognize the position, type, speed, moving direction, and the like of an object. An object to be recognized is a type of object such as a vehicle, a guard rail, a utility pole, a pedestrian, or a road sign. The object recognition device 16 outputs recognition results to the vehicle control device 100. The object recognition device 16 may output a portion of information input from the camera 10, the radar 12, or the finder 14 to the vehicle control device 100 as it is.

The HMI 20 presents various pieces of information to an occupant of the host vehicle M and receives the occupant's input operation. The HMI 20 includes various buttons such as a display unit 22, a speaker 24, and a driving support starting switch 26, a microphone, a buzzer, and the like. The apparatuses of the HMI 20 are attached to, for example, respective portions of an instrument panel, a passenger's seat, or any location on a backseat.

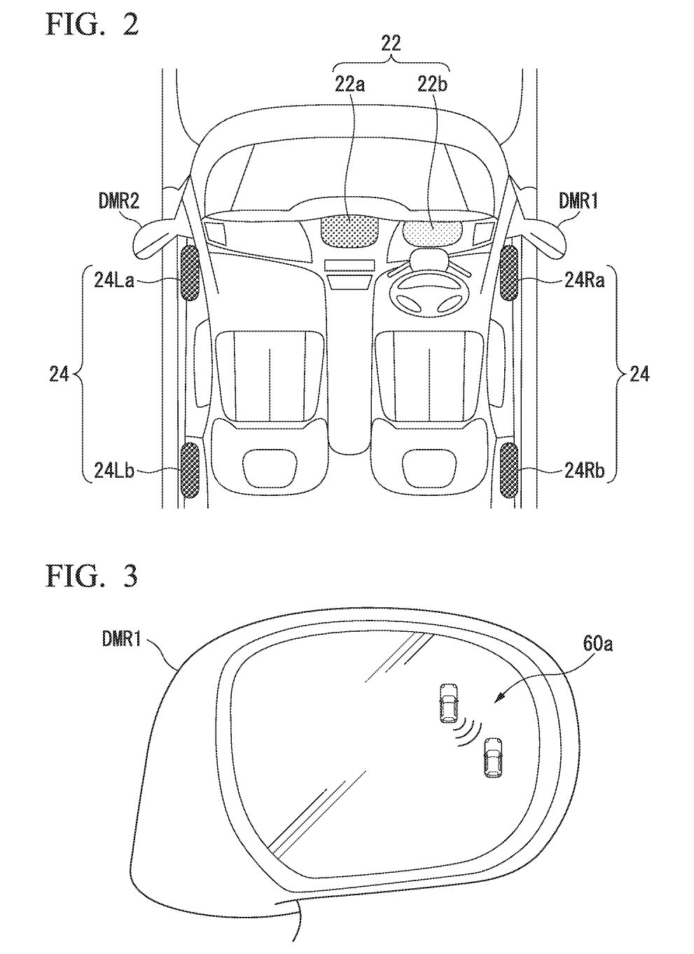

FIG. 2 is a diagram showing an example of the inside of the host vehicle M in a case where the host vehicle is viewed from above. As illustrated in the drawing, for example, the display unit 22 is positioned under the front windshield, and is installed on a dashboard provided in front of the driver's seat and the passenger's seat (22a in the drawing). For example, the display unit 22 may be installed in front of the driver's seat (22b in the drawing), and may function as an instrument panel for displaying instruments such as a speedometer and a tachometer.

The display unit 22 is any of various display devices such as a Liquid Crystal Display (LCD) and an organic Electro Luminescence (EL) display. The display unit 22 displays an image which is output by an HMI control unit 140. The display unit 22 may be a touch panel that receives the occupant's operation on a screen.

For example, the speakers 24 are installed in the vicinity of a door (24La in the drawing) closest to the passenger's seat, in the vicinity of a door (24Ra in the drawing) closest to the driver's seat, in the vicinity of a door (24Lb in the drawing) closest to a backseat behind the passenger's seat, and in the vicinity of a door (24Rb in the drawing) closest to a backseat behind the driver's seat. The speaker 24 outputs a sound, a warning sound, or the like, for example, under the control of a notification control unit 134 to be described later or the HMI control unit 140.

The driving support starting switch 26 is a switch for causing the vehicle control device 100 to start driving support control. For example, the driving support control is a control mode for controlling any one or both of the steering device 220, and the traveling driving force output device 200 and the braking device 210. On the other hand, in a case where the driving support starting switch 26 is not operated, that is, in a case where the vehicle control device 100 does not execute driving support control, manual driving is performed. In manual driving, the traveling driving force output device 200, the braking device 210, and the steering device 220 are controlled in accordance with an amount of operation of driving operators 40 which are operated by an occupant.

The vehicle sensors 30 include, for example, a vehicle speed sensor that detects the speed of the host vehicle M, an acceleration sensor that detects an acceleration, a yaw rate sensor that detects a rotational angular velocity (yaw rate) around the vertical axis through the center of gravity of the host vehicle M, a direction sensor that detects the direction of the host vehicle M, and the like. The speed includes, for example, at least one of a vertical speed with respect to the moving direction of the host vehicle M and a horizontal speed with respect to the horizontal direction of the host vehicle M. The acceleration includes, for example, at least one of a vertical acceleration with respect to the moving direction of the host vehicle M and a horizontal acceleration with respect to the horizontal direction of the host vehicle M. The sensors included in the vehicle sensor 30 outputs a detected signal indicating a detection result to the vehicle control device 100.

The driving operator 40 includes various operators such as a steering wheel for the occupant to perform a steering operation, a turn indicator lever for operating a turn indicator (directional indicator), an accelerator pedal, a brake pedal, and a shift lever. An operation detection unit detecting, for example, the amount of operation performed by the occupant is attached to each of the operators of the driving operator 40. The operation detection unit detects the position of the turn indicator lever, an amount of depression of the accelerator pedal or the brake pedal, the position of the shift lever, a steering angle and a steering torque of the steering wheel, and the like. The operation detection unit outputs a detected signal indicating a detection result to the vehicle control device 100, or any one or all of the traveling driving force output device 200, the braking device 210, and the steering device 220.

The navigation device 50 includes, for example, a Global Navigation Satellite System (GNSS) receiver 51, a navigation HMI 52, and a route determination unit 53, and stores first map information 54 in a storage device such as a Hard Disk Drive (HDD) or a flash memory. The GNSS receiver 51 identifies the position of the host vehicle M on the basis of a signal received from a GNSS satellite. The position of the host vehicle M may be specified or supplemented by an Inertial Navigation System (INS) using an output of the vehicle sensor 30. The navigation HMI 52 includes a display device, a speaker, a touch panel, a key, and the like. The navigation HMI 52 may be partially or wholly shared with respect to the HMI 20. For example, the route determination unit 53 determines a route (including, for example, information regarding transit points when the host vehicle travels to a destination) from the position (or any input position) of the host vehicle M specified by the GNSS receiver 51 to the destination input by the occupant using the navigation HMI 52 with reference to the first map information 54.

For example, the first map information 54 is information in which the form of a road is expressed by a link indicating the road and a node connected by the link. The first map information 54 includes, for example, information regarding the center of a lane, information regarding the boundary of the lane, or the like. The first map information 54 may include road information, traffic regulations information, address information (addresses and zip codes), facilities information, phone number information, and the like. The road information includes information indicating types of roads such as expressways, toll roads, national highways, and prefectural roads, and information such as a reference speed of a road, the number of lanes, the width of each lane, a gradient of the road, the position of the road (three-dimensional coordinates including the longitude, the latitude, and the height of the load), the curvature of a curve of the road or each lane of the road, the positions of convergence and branching points of lanes, and signs provided on the road. The reference speed is, for example, a legal speed, an average speed of a plurality of vehicles that traveled on the road in the past, or the like. The navigation device 50 performs route guidance using the navigation HMI 52 on the basis of the route determined by the route determination unit 53.

For example, the BSI indicator 60 displays a predetermined image 60a on a portion of a mirror surface of a door mirror DMR. For example, the door mirror DMR is provided at each of a door closest to the driver's seat and a door closest to the passenger's seat (DMR1 and DMR2 of FIG. 2). For example, the predetermined image 60a is an image for notifying the occupant that a surrounding vehicle (an example of another vehicle) is approaching the host vehicle M or that it has been estimated that a surrounding vehicle will approach the host vehicle M at a certain point in time in the future.

FIG. 3 is a diagram showing an example of the door mirror DMR1. As in the example illustrated in the drawing, the predetermined image 60a indicating that a surrounding vehicle is approaching the host vehicle M is displayed on a portion of the mirror surface of the door mirror DMR1. Similarly, the image 60a is displayed on the door mirror DMR2.

Prior to a description of the vehicle control device 100, the traveling driving force output device 200, the braking device 210, and the steering device 220 will be described. The traveling driving force output device 200 outputs a traveling driving force (torque) for the host vehicle M to travel to a drive wheel. The traveling driving force output device 200 includes, for example, a combination of an internal-combustion engine, a motor, a gearbox, and the like, and a power Electronic Control Unit (ECU) that controls these apparatuses. The power ECU controls the above-described configuration in accordance with information to be input from the vehicle control device 100 or information to be input from the driving operator 40.

The braking device 210 includes, for example, a brake caliper, a cylinder that transmits hydraulic pressure to the brake caliper, an electric motor that generates hydraulic pressure in the cylinder, and a brake ECU. The brake ECU controls the electric motor in accordance with information to be input from the vehicle control device 100 or information to be input from the driving operator 40, and causes a brake torque according to a braking operation to be output to each wheel. The braking device 210 may include a mechanism for transmitting hydraulic pressure generated due to the operation of the brake pedal included in the driving operator 40 to the cylinder through a master cylinder as a backup. The braking device 210 is not limited to the above-described configuration, and may be an electronic control type hydraulic braking device that controls an actuator in accordance with information to be input from the vehicle control device 100 and transmits hydraulic pressure of the master cylinder to the cylinder.

The steering device 220 includes, for example, a steering ECU and an electric motor. For example, the electric motor changes the direction of a turning wheel by applying a force to a rack-and-pinion mechanism. The steering ECU drives the electric motor in accordance with information to be input from the vehicle control device 100 or information to be input from the driving operator 40 to change the direction of the turning wheel.

Configuration of Vehicle Control Device

The vehicle control device 100 includes, for example, an outside recognition unit 110, a host vehicle position recognition unit 120, an apparatus operation control unit 130, and the HMI control unit 140. These components are realized by a hardware processor such as a Central Processing Unit (CPU) executing programs (software). Some or all of these components may be realized by hardware (a circuit unit; including circuitry) such as a Large Scale Integration (LSI), an Application Specific Integrated Circuit (ASIC), a Field-Programmable Gate Array (FPGA), and a Graphics Processing Unit (GPU), or may be realized by cooperation of software and hardware. These components may be realized by one processor, or may be realized by a plurality of processors. In the latter case, for example, the vehicle control device 100 may be a system in which a plurality of Electronic Control Units (ECU) are combined with each other. A combination of the outside recognition unit 110 and the host vehicle position recognition unit 120 is an example of a “recognition unit”.

The outside recognition unit 110 recognizes conditions such as the position, speed, and acceleration of a surrounding vehicle on the basis of pieces of information which are input from the camera 10, the radar 12, and the finder 14 through the object recognition device 16. The position of the surrounding vehicle may be represented by a representative point indicating the center of gravity, corner, or the like of the surrounding vehicle, or may be represented by a region expressed by the outline of the surrounding vehicle. The “conditions” of the surrounding vehicle may include the acceleration and jerk of the surrounding vehicle or “action conditions” (for example, whether or not acceleration for lane change is being performed or is being attempted). The outside recognition unit 110 may recognize conditions of other types of objects such as a guard rail, a utility pole, a parked vehicle, and a pedestrian, in addition to the surrounding vehicle.

The host vehicle position recognition unit 120 identifies the position of the host vehicle M on the basis of a signal received from a Global Navigation Satellite System (GNSS) satellite by a GNSS receiver (not shown). The position of the host vehicle M may be specified or supplemented by an Inertial Navigation System (INS) using an output of the vehicle sensor 30. The host vehicle position recognition unit 120 recognizes, for example, a lane (traveling lane) in which the host vehicle M is traveling, and the relative position and posture of the host vehicle M with respect to the traveling lane. For example, the host vehicle position recognition unit 120 recognizes lane markings LM of a road from an image captured by the camera 10, and recognizes a lane partitioned by two division lines LM closest to the host vehicle M among the recognized division lines LM as a traveling lane. The host vehicle position recognition unit 120 recognizes the position and posture of the host vehicle M with respect to the recognized traveling lane.

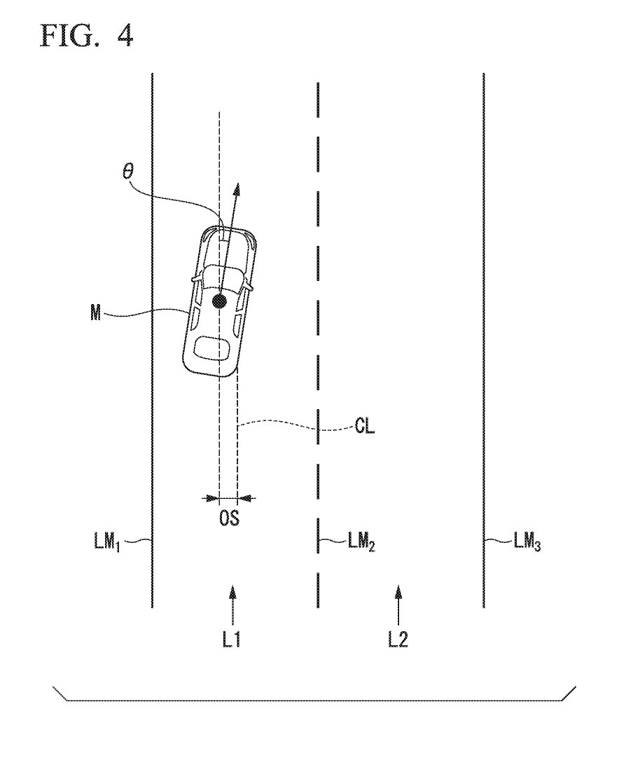

FIG. 4 is a diagram showing a state where the relative position and posture of the host vehicle M with respect to a traveling lane L1 are recognized by the host vehicle position recognition unit 120. The host vehicle position recognition unit 120 recognizes, for example, division lines LM₁ to LM₃, and recognizes a region between the division lines LM₁ and LM₂ closest to the host vehicle M as the traveling lane (an own lane) L1 of the host vehicle M. The host vehicle position recognition unit 120 recognizes a deviation OS from a traveling lane center CL being a reference point (for example, the center of gravity) of the host vehicle M and an angle θ with respect to a line connecting the traveling lane center CL in the moving direction of the host vehicle M as the relative position and posture of the host vehicle M with respect to the traveling lane L1. Alternatively, the host vehicle position recognition unit 120 may recognize the position of the reference point of the host vehicle M with respect to any side of the traveling lane L1, and the like as the relative position of the host vehicle M with respect to the traveling lane.

The host vehicle position recognition unit 120 may recognize a relative distance and a relative speed of the host vehicle M with respect to the surrounding vehicle or another object, on the basis of the recognized position and speed of the host vehicle M and the position and speed of the surrounding vehicle or another object which are recognized by the outside recognition unit 110.

The host vehicle position recognition unit 120 may recognize, for example, an adjacent lane adjacent to an own lane. For example, the host vehicle position recognition unit 120 recognizes a region between a division line closest to the host vehicle M other than the division line of an own lane and the division line of an own lane as an adjacent lane. In the example of FIG. 4, the host vehicle position recognition unit 120 recognizes a region between the division line LM₂ of an own lane and the division line LM₃ closest to the host vehicle M other than the division line LM₂ as a right adjacent lane L2.

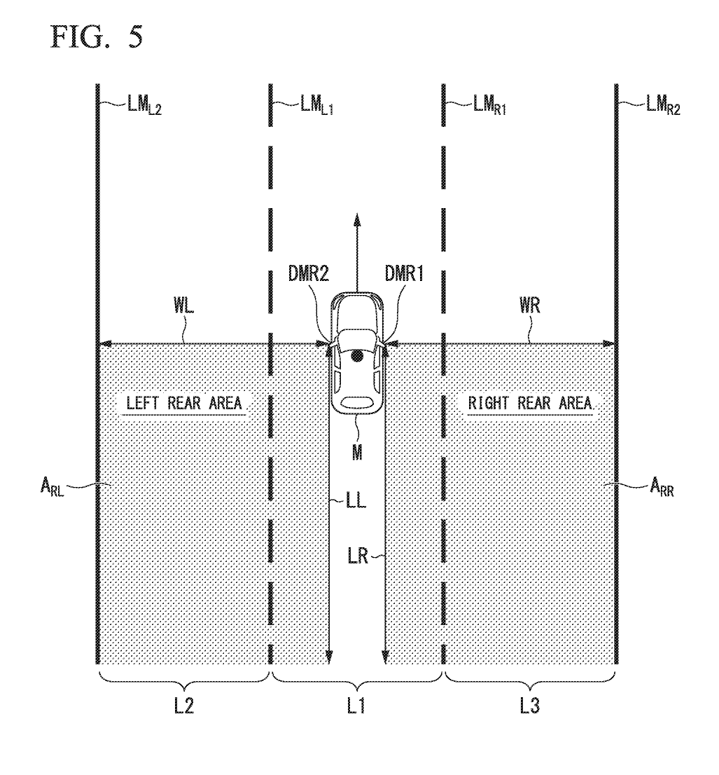

The apparatus operation control unit 130 causes an on-vehicle apparatus to perform a predetermined operation in a case where the surrounding vehicle recognized by the outside recognition unit 110 is present within a predetermined area of the host vehicle M. The predetermined area is, for example, an area on the right and left rear sides of the host vehicle M. FIG. 5 is a diagram showing an area on the side behind the host vehicle M. In the drawing, L1 denotes an own lane, L2 denotes an adjacent lane on the left side of an own lane L1 with respect to the moving direction of the host vehicle M, and L3 denotes an adjacent lane on the right side of an own lane L1 with respect to the moving direction of the host vehicle M. A contact likelihood determination unit 133 sets right and left rear areas A_{RL} and A_{RR} on an own lane L1 and the adjacent lanes L2 and L3. The left rear area A_{RL} is, for example, a region having a width WL extending from the door mirror DMR2 on the left side of the host vehicle M to a division line LM_{L2} relatively far from the host vehicle M of the lane L2 in the horizontal direction with respect to the moving direction of the host vehicle M, and a predetermined length LL on the side behind the host vehicle M from the door mirror DMR2. The right rear area A_{RR} is, for example, a region having a width WR extending from the door mirror DMR1 on the right side of the host vehicle M to a division line LM_{R2} relatively far from the host vehicle M of the lane L3 in the horizontal direction with respect to the moving direction of the host vehicle M, and a predetermined length LR on the side behind the host vehicle M from the door mirror DMR1. The predetermined area may be a side in front of the vehicle, or may be a combination of the front side and the rear side. The width and length of the predetermined area may be arbitrarily set.

The predetermined operation performed by the on-vehicle apparatus is, for example, the output of information to the occupant. The output of the information is, for example, the output of an alarm from the speaker 24 and the display of a message image on the display unit 22. For example, in a case where the surrounding vehicle recognized by the outside recognition unit 110 is present in an area on the side behind the host vehicle M, the apparatus operation control unit 130 controls the operation of the traveling driving force output device 200, the braking device 210, and the steering device 220 to avoid contact between the host vehicle M and the surrounding vehicle.

In a case where the host vehicle M turns in a specific situation, the apparatus operation control unit 130 inhibits the predetermined operation of the on-vehicle apparatus. The specific situation is a situation where the host vehicle M turns in a situation where the moving directions of the host vehicle M intersect each other such as an intersection or a T-shaped intersection. The turning means that the actual moving direction of the host vehicle M is converted due to, for example, a right turn, a left turn, a curved road, a lane change, or the like. For example, in a case where a steering angle detected by the vehicle sensor 30 is equal to or greater than a predetermined angle or in a case where a yaw rate is equal to or greater than a predetermined value, the apparatus operation control unit 130 determines that the host vehicle M is turning.

The specific situation may be determined by the operation of a turn indicator. The apparatus operation control unit 130 may determine whether or not the host vehicle M is turning in accordance with a change in positional information regarding the host vehicle M. The on-vehicle apparatus is, for example, the HMI 20, the driving operator 40, the BSI indicator 60, the traveling driving force output device 200, the braking device 210, and the steering device 220. Details of the function of the apparatus operation control unit 130 will be described later.

The HMI control unit 140 outputs processing details, processing results, or the like obtained by the vehicle control device 100 to the display device of the HMI 20, and the like. The HMI control unit 140 acquires operation details of the occupant, and the like received through the display unit 22 of the HMI 20, various buttons, or the like.

Configuration of Apparatus Operation Control Unit 130

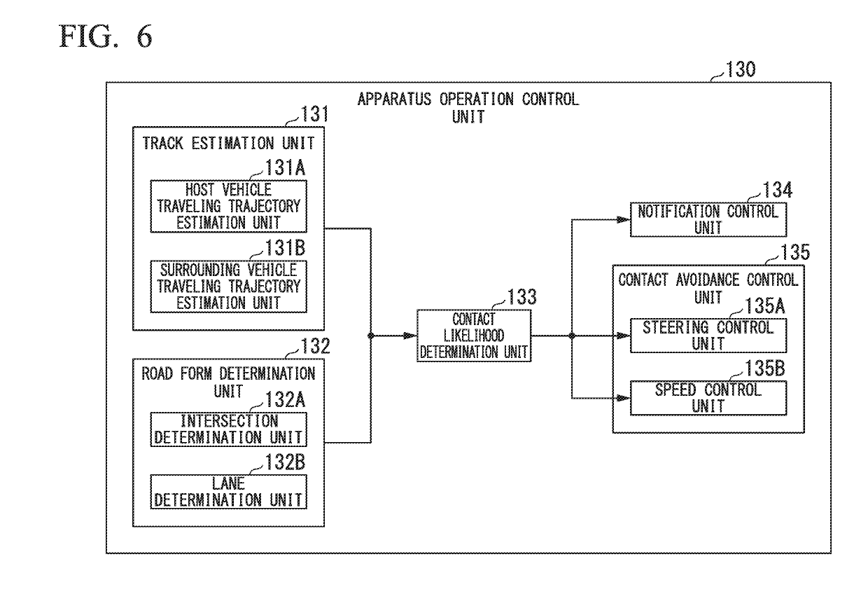

Next, a functional configuration example of the apparatus operation control unit 130 will be specifically described. FIG. 6 is a diagram showing an example of a functional configuration of the apparatus operation control unit 130. The apparatus operation control unit 130 includes, for example, a trajectory estimation unit 131, a road form determination unit 132, a contact likelihood determination unit 133, a notification control unit 134, and a contact avoidance control unit 135. A combination of the trajectory estimation unit 131, the road form determination unit 132, and the contact likelihood determination unit 133 is an example of a “turning determination unit”.

The trajectory estimation unit 131 includes, for example, a host vehicle traveling trajectory estimation unit 131A and a surrounding vehicle traveling trajectory estimation unit 131B. The host vehicle traveling trajectory estimation unit 131A estimates a future traveling trajectory of the host vehicle M from the conditions of the host vehicle M. For example, the host vehicle traveling trajectory estimation unit 131A estimates a future traveling trajectory of the host vehicle M on the basis of the position of the host vehicle M which is recognized by the host vehicle position recognition unit 120, the speed of the host vehicle M which is obtained by the vehicle sensor 30, an acceleration, a yaw rate, a steering angle of the steering wheel, an amount of depression of the accelerator pedal or the brake pedal, the form of a road, and the like. The host vehicle traveling trajectory estimation unit 131A determines whether or not the host vehicle is turning, on the basis of the steering angle of the steering wheel, the yaw rate, and the like. The host vehicle traveling trajectory estimation unit 131A estimates a lane on which the host vehicle M is traveling or a lane on which the host vehicle M will travel in the future, on the basis of the traveling trajectory of the host vehicle M and determination results obtained by the road form determination unit 132.

The surrounding vehicle traveling trajectory estimation unit 131B acquires a position and a speed for each surrounding vehicle recognized by the outside recognition unit 110, and estimates a future traveling trajectory for each surrounding vehicle on the basis of the acquired position and speed. The surrounding vehicle traveling trajectory estimation unit 131B estimates a lane on which the surrounding vehicle is traveling or a lane on which the surrounding vehicle will travel in the future, on the basis of the traveling trajectory of the surrounding vehicle and determination results obtained by the road form determination unit 132.

The road form determination unit 132 includes, for example, an intersection determination unit 132A and a lane determination unit 132B. For example, the intersection determination unit 132A determines whether or not the current position of the host vehicle M is in the vicinity of an intersection with reference to the first map information 54 of the navigation device 50, on the basis of the position of the host vehicle M which is recognized by the host vehicle position recognition unit 120. The vicinity of the intersection includes, for example, a range of a predetermined distance (for example, 10 [m] to 30 [m]) before the host vehicle passes the intersection or after the host vehicle passes the intersection.

In a case that the intersection determination unit 132A detects predetermined signs, such as a traffic light, a pedestrian crossing, an intersection sign, or the like located in front of the host vehicle M, in an image captured by the camera 10, it may be determined that there is an intersection in the vicinity in front of the host vehicle M.

The lane determination unit 132B determines the relative position of a lane of a road on which the host vehicle M is traveling or a lane of a road several [m] to several tens [m] ahead of the host vehicle M with respect to the host vehicle M, and the like with reference to the first map information 54 of the navigation device 50, on the basis of the position of the host vehicle M which is recognized by the host vehicle position recognition unit 120. The lane determination unit 132B may determine whether or not the number of lanes in which the host vehicle is traveling or the number of lanes in which the host vehicle will travel in the future is two or more.

The contact likelihood determination unit 133 determines whether or not there is a likelihood that the host vehicle M comes into contact with the surrounding vehicle recognized by the outside recognition unit 110. For example, the contact likelihood determination unit 133 determines whether or not there is a likelihood that the host vehicle M comes into contact with the surrounding vehicle, on the basis of the traveling trajectory of the host vehicle M which is estimated by the host vehicle traveling trajectory estimation unit 131A and the traveling trajectory of the surrounding vehicle which is estimated by the surrounding vehicle traveling trajectory estimation unit 131B.

For example, the contact likelihood determination unit 133 detects surrounding vehicles that are present in an area on the side behind the subject vehicle M and from which a distance to the host vehicle M is less than a predetermined value. The contact likelihood determination unit 133 calculates a predicted time (margin time) TTC until contact with the host vehicle M will occur for surrounding vehicles whose distance is less than the predetermined value. The TTC is calculated, for example, by dividing a relative distance by a relative speed (relative distance/relative speed). Then, in a case that the TTC is less than or equal to the threshold value, the contact likelihood determination unit 133 determines that there is a likelihood of contact with a surrounding vehicle. In a case that it is determined that there is a likelihood of contact with a surrounding vehicle, the contact likelihood determination unit 133 causes the notification control unit 134 to perform notification control or to perform contact avoidance control using the contact avoidance control unit 135.

The contact likelihood determination unit 133 determines whether or not the host vehicle M is turning in a specific situation. In a case where it is determined that the host vehicle is turning in the specific situation, the contact likelihood determination unit inhibits control to be performed by the notification control unit 134, a steering control unit 135A, and a speed control unit 135B. Details of the function of the contact likelihood determination unit 133 will be described later.

For example, the notification control unit 134 outputs a predetermined notification from the on-vehicle apparatus on the basis of determination results obtained by the contact likelihood determination unit 133. For example, the predetermined notification is an alarm or an image displayed on the display unit 22. Details of the function of the notification control unit 134 will be described later.

The contact avoidance control unit 135 performs driving support for controlling the steering and speed of the host vehicle M in order to avoid contact with the surrounding vehicle, on the basis of determination results obtained by the contact likelihood determination unit 133. For example, the contact avoidance control unit 135 performs driving support for avoiding contact by performing lane deviation inhibition control for controlling steering so as to prevent the host vehicle M from deviating from a traveling lane (an own lane), in a case where it is estimated that there is a likelihood that the host vehicle comes into contact with a surrounding vehicle traveling in a lane being a lane change destination when performing a lane change. In the lane deviation inhibition control, the speed of the host vehicle M may be controlled in addition to the control of steering.

The contact avoidance control unit 135 includes, for example, the steering control unit 135A and the speed control unit 135B. In a case where there is a surrounding vehicle for which the contact likelihood determination unit 133 estimates that the host vehicle is likely to come into contact with the surrounding vehicle, the steering control unit 135A adjusts the amount of control of a steering angle and a steering torque of the steering wheel so that the host vehicle M avoids contact with the surrounding vehicle, and outputs the adjusted amount of control to the steering device 220.

In a case where there is a surrounding vehicle for which the contact likelihood determination unit 133 estimates that the host vehicle is likely to come into contact with the surrounding vehicle, the speed control unit 135B adjusts an amount of depression of the accelerator pedal and the brake pedal so that the host vehicle M avoids contact with the surrounding vehicle, and outputs the adjusted amount of control to the traveling driving force output device 200 and the braking device 210.

Example of Situations in which Driving Support Control is Executed

Hereinafter, various situation examples in which driving support control is executed by the vehicle control device 100 will be described.

### First Situation Example

First, as a first situation example in which driving support control is executed, control details of the driving support control in a state where a surrounding vehicle V_{RS} is approaching from the side behind the host vehicle M on an adjacent lane will be described.

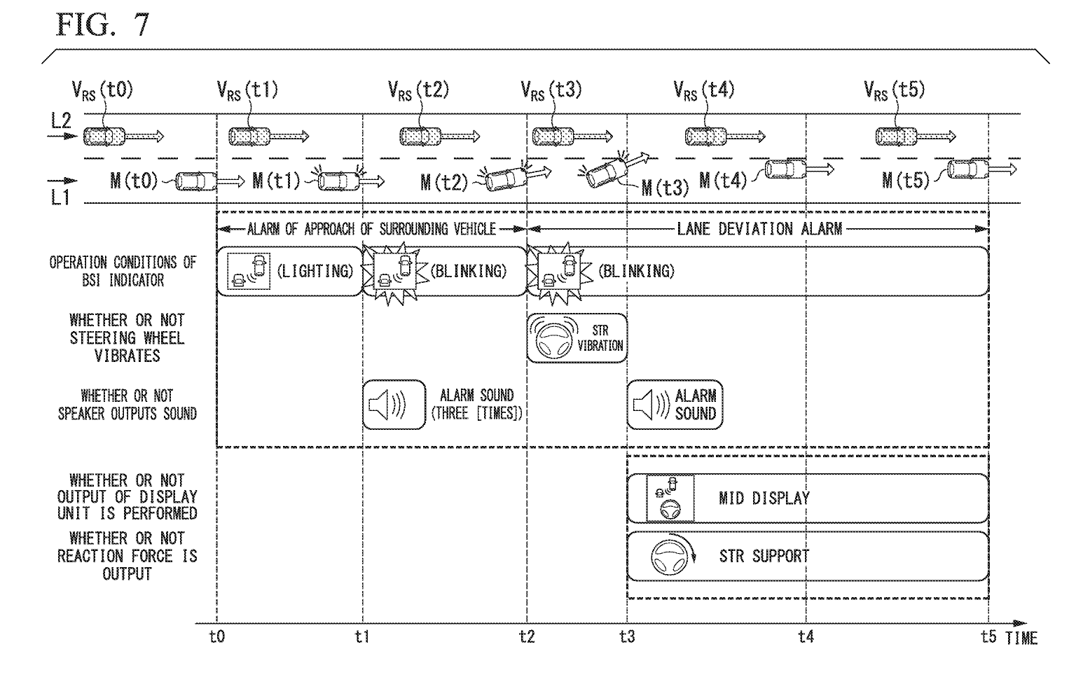

FIG. 7 is a diagram showing control details of driving support control in a situation where the surrounding vehicle V_{RS} from the side behind the host vehicle M on an adjacent lane. In the drawing, traveling positions of the host vehicle M traveling in the lane L1 and the surrounding vehicle V_{RS} traveling in the lane L2 at times t0 to t5 and control details of the on-vehicle apparatus of the host vehicle M at each of the times are shown.

For example, time t0 in the drawing indicates a time when it is detected that the surrounding vehicle V_{RS} is present within an area on the side behind the host vehicle M. In this case, the notification control unit 134 operates the BSI indicator 60 to display the predetermined image 60a on a portion of the mirror surface of the door mirror DMR2 ((lighting) in the drawing). Thereby, it is possible to notify the occupant of the host vehicle M that the surrounding vehicle V_{RS} is approaching.

Time t1 indicates a time when the turn indicator of the host vehicle M is operated by operating the turn indicator lever, which is an example of a driving operator, in order for the occupant to perform a lane change. In this case, it is assumed that the occupant of the host vehicle M instructs a lane change without recognizing the presence of the surrounding vehicle V_{RS}. Therefore, even when the host vehicle M does not approach a division line, the notification control unit 134 blinks the predetermined image 60a displayed on the mirror surface of the door mirror DMR2 by controlling the BSI indicator 60 as a first alarm output, for example, at a point of time t1 when the predicted time (margin time) TTC is set to be equal to or less than a threshold value ((blinking) in the drawing). The notification control unit 134 controls the speaker 24 such that an alarm sound is output a predetermined number of times (three times in the example illustrated in the drawing) at a timing when the predetermined image 60a flashes, as the first alarm output. Thereby, it is possible to more strongly draw attention of the occupant having instructed the lane change than before the turn indicator is operated.

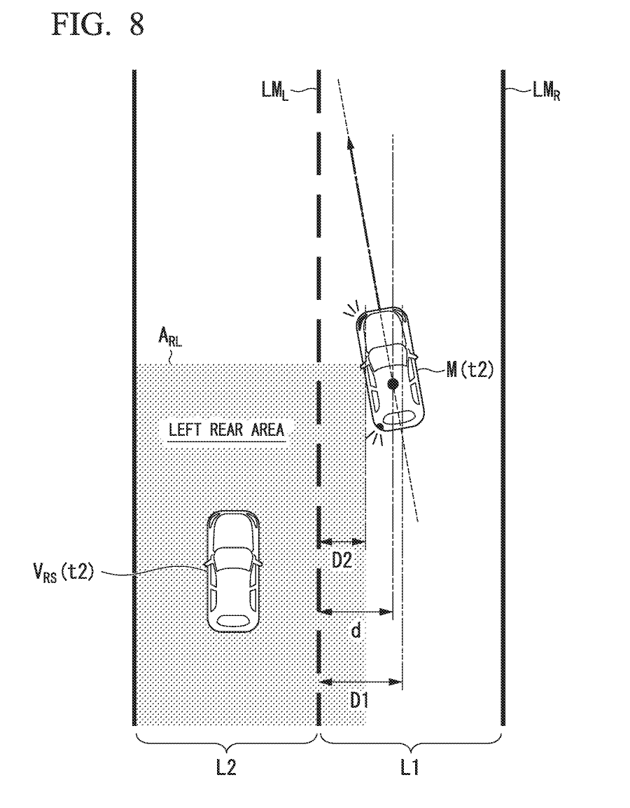

Time t2 indicates a time when the occupant attempts to move the host vehicle M from the lane L1 to the lane L2 by operating the steering wheel, which is an example of a driving operator, in order to perform a lane change. Here, FIG. 8 is a diagram showing a traveling state of the host vehicle M at time t2. In the drawing, LM_{L} denotes a division line on the left side in the moving direction out of two division lines for partitioning an own lane L1, and LM_{R} denotes a division line on the right side in the moving direction out of the two division lines for partitioning an own lane L1. In the example illustrated in the drawing, it is shown that the surrounding vehicle V_{RS} traveling in the lane L2 on the left side is present within a predetermined distance from the host vehicle M.

For example, the contact likelihood determination unit 133 determines whether or not the host vehicle M has approached the division line LM_{L} until a distance d between the division line LM_{L} and the center of gravity of the host vehicle M is set to be equal to or less than a first distance threshold value DE Alternatively, the contact likelihood determination unit 133 may determine whether a lane deviation determination time TTLC (Time To Lane Crossing), which is a time until the host vehicle M will cross lane markings, is less than or equal to a predetermined first time threshold value TTLC. In a case where it is determined that the host vehicle M has approached the division line LM_{L} until the distance d is set to be equal to or less than the first distance threshold value D1 or in a case where it is determined that TTLC is equal to or less than TTLC1, the contact likelihood determination unit 133 determines whether or not the host vehicle M is turning in a specific situation. For example, the contact likelihood determination unit 133 refers to the first map information 54 on the basis of the position of the host vehicle M which is recognized by the host vehicle position recognition unit 120, and determines that the host vehicle is not turning in a specific situation such as an intersection or a T-shaped intersection because the current position is not in the specific situation. Therefore, the contact likelihood determination unit 133 causes the on-vehicle apparatus to perform a predetermined operation without inhibiting the control of the notification control unit 134.

The contact likelihood determination unit 133 may vibrate the steering wheel by operating the vibrator provided in the steering wheel, as preliminary control before contact avoidance control is executed by the contact avoidance control unit 135. The contact likelihood determination unit 133 determines whether or not TTLC is equal to or less than TTLC1 determined in advance. In a case where it is determined that TTLC is equal to or less than TTLC1, the contact likelihood determination unit may vibrate the steering wheel by operating the vibrator. Thereby, it is possible to prompt the occupant to operate the steering wheel to travel in the center of the lane.

The time t3, which is after the steering wheel is vibrated, and at which the occupant is not operating the steering wheel (the steering angle or the steering torque are less than a threshold value), indicates a time at which the subject vehicle has approached nearer to the lane markings LM_{L}, and the distance d between the lane markings LM_{L} and the subject vehicle M has becomes less than or equal to the second distance threshold D2 which is smaller than the first distance threshold value D1. Time t3 may be a time when a predetermined period of time elapses after the steering wheel is vibrated. In this case, the contact avoidance control unit 135 stops vibrating the steering wheel, and performs lane deviation inhibition control so that the host vehicle M returns to the center side of the lane, as contact avoidance control. Similarly to the first distance threshold value D1, the second distance threshold value D2 is a distance in the width direction of the vehicle when a length determined in advance is taken to the center side of the lane with a division line for partitioning an own lane as a reference. For example, in a case where the center of gravity of the host vehicle M approaches the division line until the distance therebetween is set to be equal to or less than the second distance threshold value D2 when viewed from above, the distance is set to be such a distance that a portion of the body of the host vehicle M goes beyond the division line.

The contact likelihood determination unit 133 may determine whether or not an estimated lane deviation time TTLC (=d/v1) obtained by dividing the distance d by a horizontal speed v1 of the host vehicle M is equal to or less than the second time threshold value TTLC2. In a case where the estimated lane deviation time TTLC is equal to or less than the second time threshold value TTLC2, the contact avoidance control unit 135 performs steering control so that the host vehicle M returns to the center side of the lane. For example, the second time threshold value TTLC2 may be set to be a period of time shorter than the first time threshold value TTLC1.

The notification control unit 134 causes the speaker 24 to output an alarm sound as a second alarm output, and displays the display unit 22 to display an image indicating that the host vehicle M and the surrounding vehicle V_{RS} are approaching each other (Multi Information Display (MID) display in the drawing). The steering control unit 135A may output a reaction force to the steering wheel (STR support in the drawing).

Time t4 indicates a time at which the host vehicle M has returned to an own lane L1 due to contact avoidance control. In such a case, the notification control unit 134 stops the blinking display of the image 60a which is performed by the operation of the BSI indicator 60 and terminates the notification control of MID display at a point in time when a predetermined period of time elapses after the host vehicle M returns to an own lane or at a point in time when the host vehicle M travels by a predetermined distance (time t5 in the drawing). The contact avoidance control unit 135 terminates the contact avoidance control such as the lane deviation inhibition control.

### Second Situation Example

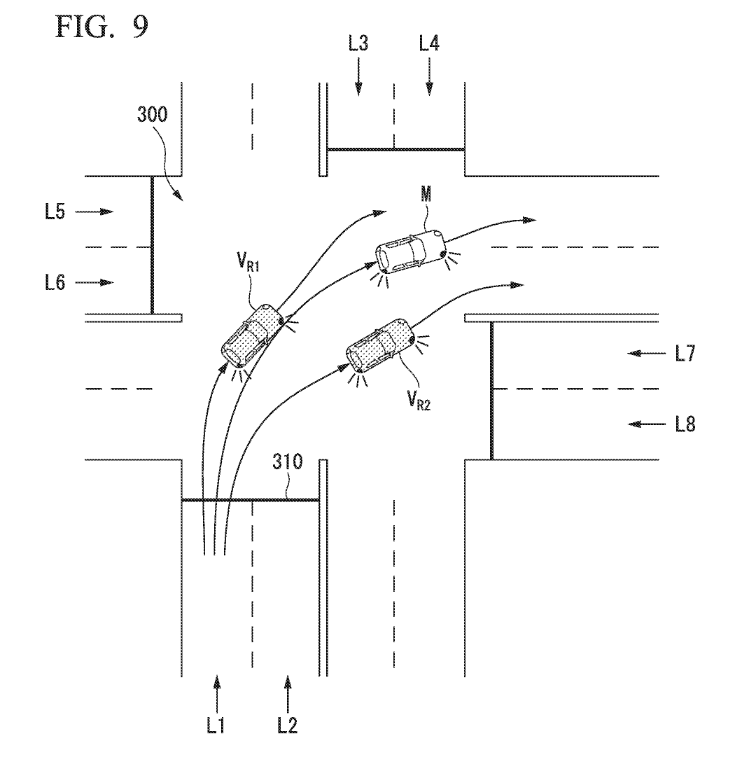

Next, a second situation example in which driving support control is executed will be described. FIG. 9 is a diagram showing an example in which the likelihood of contact with a following vehicle in a case of turning right at an intersection in a second situation is determined. In the example of FIG. 9, two-lane roads (lanes L1 to L8) and an intersection 300 are shown. In the second situation example, it is assumed that a relative distance between each of surrounding vehicles V_{R1} and V_{R2} and the host vehicle M is less than a predetermined value. In the second situation example, it is assumed that the host vehicle M and the surrounding vehicles V_{R1} and V_{R2} travel in the lane L1 and turn right at the intersection 300. In the second situation example, it is assumed that it is estimated that the host vehicle M and the surrounding vehicle V_{R1} travel in a left lane L5 out of two lanes L5 and L6 which are right-turn destinations and the surrounding vehicle V_{R2} travels in the right lane L6 different from the lane of the host vehicle M, on the basis of the host vehicle traveling trajectory estimation unit 131A and the surrounding vehicle traveling trajectory estimation unit 131B.

In this case, the contact likelihood determination unit 133 determines that there is a likelihood of contact because TTC is set to be equal to or less than a threshold value when the host vehicle M and the surrounding vehicles V_{R1} and V_{R2} turn right. The contact likelihood determination unit 133 determines whether or not each of the surrounding vehicles V_{R1} and V_{R2} turns in a specific situation.

For example, the contact likelihood determination unit 133 determines that the host vehicle M turns in a specific situation in a case where the host vehicle M turns right or turns left at the intersection 300, on the basis of the traveling trajectory of the host vehicle which is estimated by the host vehicle traveling trajectory estimation unit 131A. The contact likelihood determination unit 133 may determine that the host vehicle M turns right or turns left (that is, the host vehicle is turning) at an intersection, a T-shaped intersection, or the like in a case where a steering angle is equal to or greater than a predetermined angle or a yaw rate is equal to or greater than a predetermined value in a state where the host vehicle M operates the turn indicator.

The contact likelihood determination unit 133 may determine that the host vehicle M turns right or turns left at the intersection 300 (that is, the host vehicle is turning) in a case where the host vehicle stops in the vicinity of a stop line 310 in front of the intersection 300 with the turn indicator operated and starts traveling by a signal turning to a green light. The contact likelihood determination unit 133 may determine that the host vehicle M is turning in a case where the steering angle is equal to or greater than the predetermined angle or the yaw rate is equal to or greater than the predetermined value in a state where the braking device 210 is operated by the operation of the brake pedal.

The contact likelihood determination unit 133 may determine that the host vehicle M is turning at an intersection in a case where it is determined that the host vehicle M will turn right or turn left across the opposite lane corresponding to the lane on which the host vehicle is traveling. In the example of FIG. 9, the host vehicle M turns right across the lanes L3 and L4 opposite to the lane L1 in which the host vehicle is traveling, and thus it is determined that the host vehicle M is turning in a specific situation.

The contact likelihood determination unit 133 may determine that the host vehicle M is turning in a case where a turn indicator corresponding to a route direction is operated and the future route of the host vehicle M, which is obtained by the navigation device 50, being a right turn or a left turn at an intersection or the like or in a case where a steering angle and a yaw rate change along the route. The contact likelihood determination unit 133 may determine whether or not the host vehicle M is turning by combining a plurality of conditions among the above-described plurality of conditions for the determination of turning.

The contact likelihood determination unit 133 inhibits notification control to be performed by the notification control unit 134 in a case where it is determined that the host vehicle M is turning in a specific situation.

The contact likelihood determination unit 133 may cause the notification control unit 134 to execute notification control and cause the contact avoidance control unit 135 to execute contact avoidance control in a case where an action in which the surrounding vehicle V approaches a lane adjacent to the traveling lane of the host vehicle M, and thereafter, the host vehicle M moves to the adjacent lane is performed, on the basis of the traveling lane of the host vehicle M and the traveling lanes of the surrounding vehicles V_{R1} and V_{R2} of which are determined by the lane determination unit 132B.

In the example of FIG. 9, the surrounding vehicle V_{R1} travels in the same lane L5 as the host vehicle M. Therefore, the contact likelihood determination unit 133 inhibits notification to be performed by the notification control unit 134 even when it is determined that there is a likelihood that the host vehicle comes into contact with the surrounding vehicle.

The surrounding vehicle V_{R2} travels in the lane L6 adjacent to the lane L5 in which the host vehicle M travels. For this reason, the contact likelihood determination unit 133 causes the notification control unit 134 to execute notification control and causes the contact avoidance control unit 135 to execute contact avoidance control with respect to the surrounding vehicle V_{R2}, on the basis of a relative distance, TTC, and the like.

### Third Situation Example

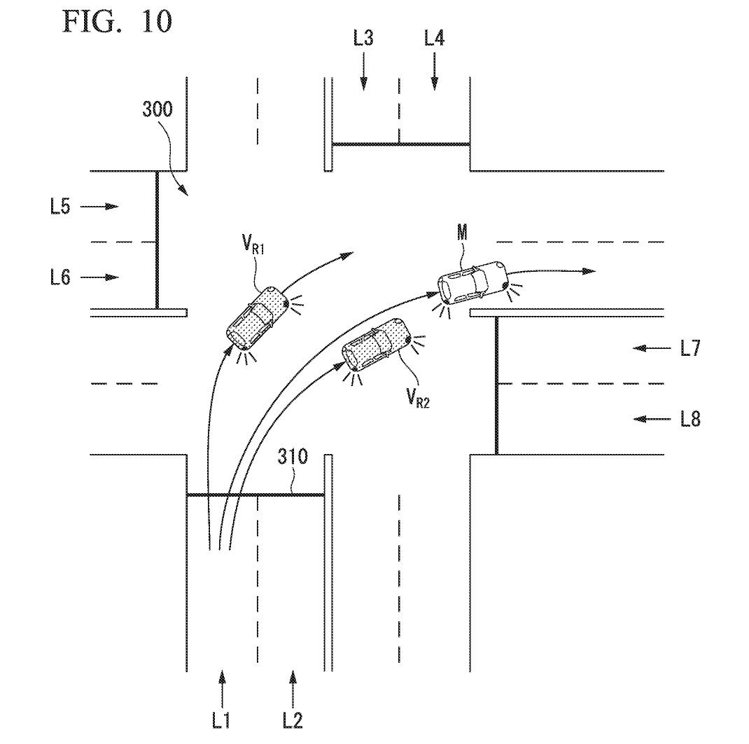

Next, a third situation example in which driving support control is executed will be described. FIG. 10 is a diagram showing an example in which the likelihood of contact with a following vehicle in a case of turning right at an intersection is determined in a third situation. The third situation example is different from the second situation example in that it is estimated that the vehicle M and the surrounding vehicle V_{R2} travel in the right lane L6 out of two lanes L5 and L6 which are right-turn destinations and it is estimated that the surrounding vehicle V_{R1} travels in the left lane L5 different from the lane of the host vehicle M. Therefore, in the following description, the above-described difference will be particularly described.

In the third situation example, the surrounding vehicle V_{R1} travels in the lane L5 different from the host vehicle M, but moves to the outer lane L5 having an arc larger than that of the host vehicle M, and thus there is a low likelihood that the surrounding vehicle comes into contact with the host vehicle M. Therefore, the contact likelihood determination unit 133 inhibits notification control to be performed by the notification control unit 134 in a case where the degree of likelihood is equal to or less than a predetermined value, even when it is determined that there is a likelihood that the host vehicle comes into contact with the surrounding vehicle. In this case, the contact likelihood determination unit 133 may perform determination by lowering a threshold value of TTC, which is used when determining whether or not there is a likelihood that the host vehicle comes into contact with the surrounding vehicle V_{R1}, below a reference value on the basis of a predicted time (margin time) TTC during the turning of the host vehicle M.

Since the surrounding vehicle V_{R2} travels in the same lane L6 as the lane on which the host vehicle M travels, the contact likelihood determination unit 133 inhibits notification control to be performed by the notification control unit 134. In this manner, in the second situation example and the third situation example, it is possible to inhibit a predetermined operation of the on-vehicle apparatus in a case where there is a surrounding vehicle approaching the host vehicle M.

Processing Flow

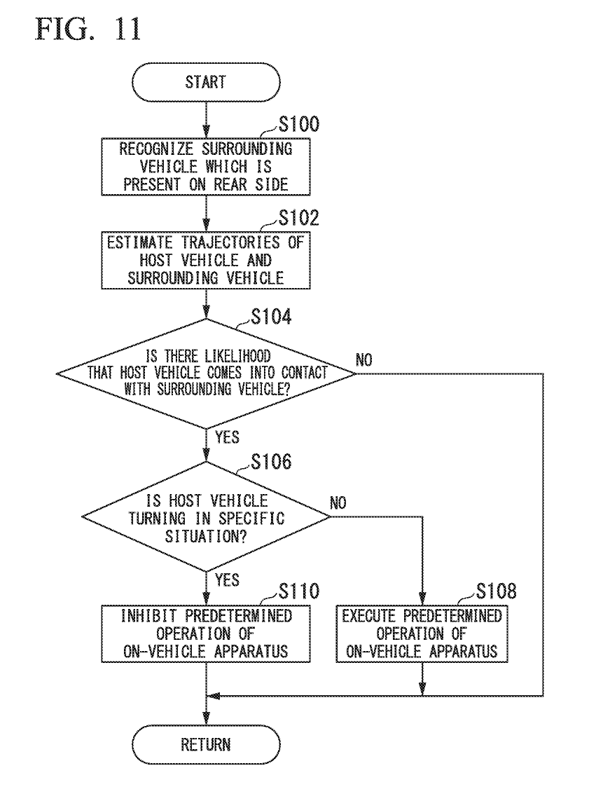

FIG. 11 is a flowchart showing an example of a flow of vehicle control processing according to the embodiment. For example, the processing of the present flowchart may be repeatedly executed at predetermined cycles or at a predetermined timing during the execution of driving control. First, the outside recognition unit 110 recognizes a surrounding vehicle which is present in an area set on the side behind the host vehicle M (step S100). Next, the host vehicle position recognition unit 120 estimates trajectories of the host vehicle M and the surrounding vehicle (step S102). Next, the contact likelihood determination unit 133 determines whether or not there is a likelihood that the host vehicle M comes into contact with the surrounding vehicle (step S104). In a case where it is determined that there is a likelihood that the host vehicle comes into contact with the surrounding vehicle, the contact likelihood determination unit 133 determines whether or not the host vehicle M is turning in a specific situation (step S106). In a case where it is determined that the host vehicle is not turning in a specific situation, the contact likelihood determination unit 133 causes the on-vehicle apparatus to execute a predetermined operation (step S108). In a case where it is determined that the host vehicle is turning in a specific situation, the contact likelihood determination unit 133 inhibits the predetermined operation of the on-vehicle apparatus (step S110). Thereby, the processing of the present flowchart is terminated. Also in a case where it is determined in the process of step S104 that there is no likelihood that the host vehicle M comes into contact with the surrounding vehicle, the processing of the present flowchart is terminated.

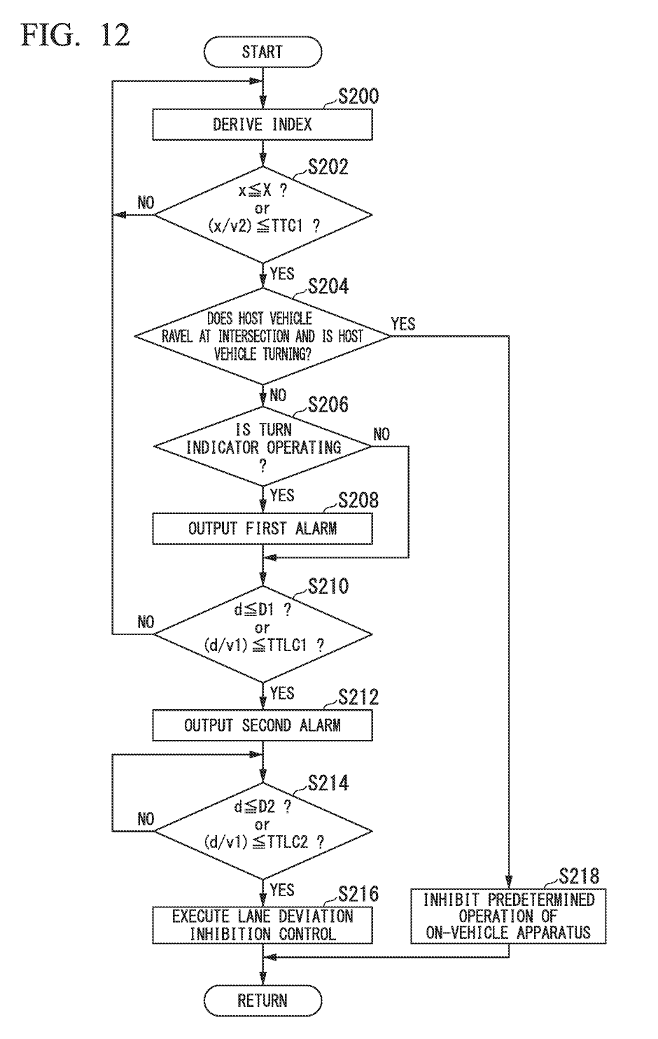

FIG. 12 is a flowchart showing an example of a detailed flow of the vehicle control processing according to the embodiment. First, the trajectory estimation unit 131 derives an index related to the action of the host vehicle M (step S200). In the process of step S200, for example, a distance d between the host vehicle M and a lane division line is calculated, a horizontal speed v1 of the host vehicle M is calculated, a distance x between the host vehicle M and a surrounding vehicle (for example, a vehicle on the rear side) is calculated, or a relative speed v2 between the host vehicle M and the surrounding vehicle is calculated.

Next, the contact likelihood determination unit 133 determines whether or not the distance x from the surrounding vehicle is equal to or less than a threshold value X or whether or not TTC (x/v2) is equal to or less than the first threshold value TTC1 (step S202). In a case where it is determined that the distance x from the surrounding vehicle is not equal to or less than the threshold value X and TTC (x/v2) is not equal to or less than the first threshold value TTC1, the processing returns to the process of step S200. In a case where it is determined that the distance x from the surrounding vehicle is equal to or less than the threshold value X or TTC (x/v2) is equal to or less than the first threshold value TTC1, the contact likelihood determination unit 133 determines whether or not the host vehicle M travels at an intersection and is turning (step S204).

In a case where it is determined that the host vehicle M is not traveling at an intersection or the host vehicle M is not turning, the contact likelihood determination unit 133 determines whether or not the turn indicator is operating (step S206). In a case where it is determined that the turn indicator is operating, the notification control unit 134 outputs a first alarm (step S208). In step S206, in a case where the turn indicator is not operating or after the process of step S208 is performed, the contact likelihood determination unit 133 determines whether or not the distance d between the host vehicle M and the lane division line is equal to or less than the threshold value D1 or TTLC (d/v1) is equal to or less than the first threshold value TTLC1 (step S210). In a case where it is determined that the distance d between the host vehicle M and the lane division line is not equal to or less than the threshold value D1 and TTLC (d/v1) is not equal to or less than the first threshold value TTLC1, the processing returns to the process of step S200. In a case where it is determined that the distance d between the host vehicle M and the lane division line is equal to or less than the threshold value D1 or TTLC (d/v1) is equal to or less than the first threshold value TTLC1, the notification control unit 134 outputs a second alarm (step S212).

Next, the contact likelihood determination unit 133 stands by until the distance d is set to be equal to or less than the second distance threshold value D2 or the estimated lane deviation time TTLC (=d/v1) is set to be equal to or less than the second time threshold value TTLC2 (step S214), and executes lane deviation inhibition control when the distance d is set to be equal to or less than the second distance threshold value D2 or TTLC is set to be equal to or less than the second time threshold value TTLC2 (step S216). In the process of step S214, for example, in a case where the distance d is set to be equal to or greater than the first distance threshold value D1, or the like, processing such as returning to the process of step S200 or termination of the processing of the present flowchart may be performed.

In a case where it is determined in step S204 that the host vehicle M travels at an intersection and is turning, a predetermined operation of the on-vehicle apparatus is inhibited (step S218). Thereby, the processing of the present flowchart is terminated.

According to the above-described embodiment, the vehicle control device 100 can appropriately inhibit a predetermined operation of the on-vehicle apparatus. Therefore, for example, in a case where the host vehicle M is turned left or turned right in a situation where the moving directions of the host vehicle M intersect each other, the vehicle control device 100 can inhibit the giving of notice of an alarm or the like even when a following vehicle having turned in the same direction as the host vehicle M is detected as another vehicle likely to come into contact with the host vehicle.

Hardware Configuration

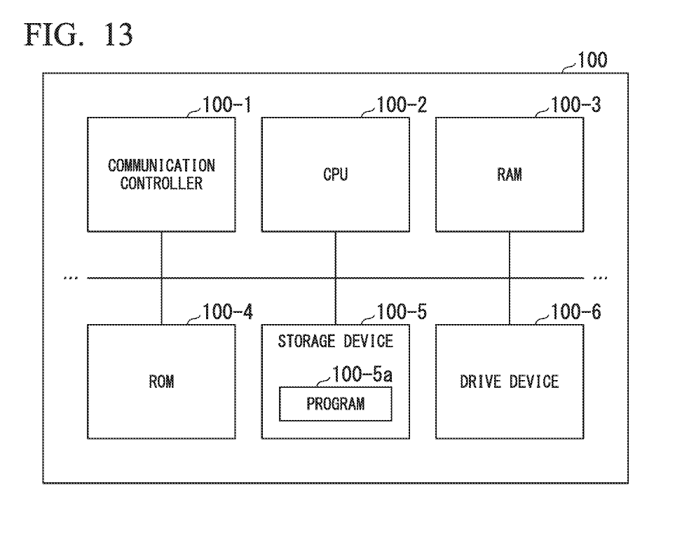

The vehicle control device 100 according to the above-described embodiment is realized by a hardware configuration as illustrated in, for example, FIG. 13. FIG. 13 is a diagram showing an example of a hardware configuration of the vehicle control device 100 according to the embodiment.

The vehicle control device 100 is configured such that a communication controller 100-1, a CPU 100-2, a Random Access Memory (RAM) 100-3, a Read Only Memory (ROM) 100-4, a storage device 100-5 such as a flash memory or HDD, and a drive device 100-6 are connected to each other through an internal bus or a dedicated communication line. The drive device 100-6 is mounted with a portable storage medium such as an optical disk. A program 100-5a stored in the storage device 100-5 or a program stored in the portable storage medium mounted in the drive device 100-6 is developed to the RAM 100-3 by a Direct Memory Access (DMA) controller (not shown) or the like and is executed by the CPU 100-2, so that each of the functions of the vehicle control device 100 is realized. A program to be referred to by the CPU 100-2 may be downloaded from another device through a network such as the Internet.

The above-described embodiment can be expressed as follows.

A vehicle control device including:

a storage device that stores information; and

a hardware processor that executes a program,

wherein the storage device stores the program for causing the hardware processor to execute

a recognition process of recognizing another vehicle in the vicinity of a host vehicle,

a turning determination process of determining whether or not the host vehicle is turning in a specific situation, and

an apparatus operation control process of causing an on-vehicle apparatus to perform a predetermined operation in a case where the other vehicle recognized by the recognition process is present within a predetermined area of the host vehicle, and

the apparatus operation control process includes inhibiting the operation to be performed by the on-vehicle apparatus in a case where it is determined by the turning determination process that the host vehicle is turning in the specific situation.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognition unit that recognizes another vehicle in a vicinity of a host vehicle;
a turning determination unit that determines whether or not the host vehicle is turning in a specific situation; and
an apparatus operation control unit that causes an on-vehicle apparatus to perform a predetermined operation in a case where the other vehicle recognized by the recognition unit is present within a predetermined area of the host vehicle,
wherein the apparatus operation control unit inhibits the predetermined operation to be performed by the on-vehicle apparatus in a case where the turning determination unit determines that the host vehicle is turning in the specific situation.

2. The vehicle control device according to claim 1,
wherein the predetermined area is an area set on a side behind the host vehicle.

3. The vehicle control device according to claim 1,
wherein the turning in the specific situation is a right turn or a left turn in a situation where moving directions of the host vehicle intersect each other.

4. The vehicle control device according to claim 1, further comprising:
a road form determination unit that determines whether or not a form of a road on which the host vehicle travels includes a plurality of lanes; and
a trajectory estimation unit that estimates a trajectory on which the host vehicle will travel and a trajectory on which the other vehicle will travel, in a case where the road form determination unit determines that a road onto which the host vehicle is turning includes a plurality of lanes,
wherein the apparatus operation control unit causes the on-vehicle apparatus to perform the predetermined operation in a case where the road form determination unit determines that a road onto which the host vehicle is turning includes a plurality of lanes and a case where a lane on which the host vehicle will travel after turning, which is estimated by the trajectory estimation unit, and a lane on which the other vehicle will travel after turning are different from each other.

5. The vehicle control device according to claim 1,
wherein the apparatus operation control unit inhibits the predetermined operation to be performed by the on-vehicle apparatus, in a case where it is determined that the host vehicle will turn right or turn left across a lane opposite to a lane on which the host vehicle travels.

6. The vehicle control device according to claim 1,
wherein the turning determination unit determines whether or not the host vehicle is turning, on the basis of operation conditions of a directional indicator of the host vehicle.

7. The vehicle control device according to claim 1, further comprising:
an operation detection unit that detects a steering angle of a steering wheel for an occupant of the host vehicle to perform a steering operation,
wherein the turning determination unit determines whether or not the host vehicle is turning, on the basis of whether or not the steering angle of the host vehicle which is detected by the operation detection unit is equal to or greater than a predetermined angle.

8. The vehicle control device according to claim 1, further comprising:
a yaw rate sensor that detects a yaw rate of the host vehicle,
wherein the turning determination unit determines whether or not the host vehicle is turning, on the basis of whether or not the yaw rate of the host vehicle which is detected by the yaw rate sensor is equal to or greater than a predetermined value.

9. The vehicle control device according to claim 1,
wherein the turning determination unit determines whether or not the host vehicle is turning, on the basis of whether or not a braking device of the host vehicle is operating.

10. The vehicle control device according to claim 1, further comprising:
a navigation device that outputs information regarding a route to a destination of the host vehicle,
wherein the turning determination unit determines whether or not the host vehicle is turning, on the basis of a future route of the host vehicle which is obtained by the navigation device.

11. A vehicle control method executed by a computer mounted on a host vehicle, the vehicle control method comprising;
recognizing another vehicle in a vicinity of the host vehicle;
determining whether or not the host vehicle is turning in a specific situation;
causing an on-vehicle apparatus to perform a predetermined operation in a case where the other vehicle recognized is present within a predetermined area of the host vehicle; and
inhibiting the predetermined operation to be performed by the on-vehicle apparatus in a case where it is determined that the host vehicle is turning in the specific situation.

12. A non-transitory computer-readable storage medium storing a program causing an on-vehicle computer to:
recognize another vehicle in a vicinity of a host vehicle;
determine whether or not the host vehicle is turning in a specific situation;
cause an on-vehicle apparatus to perform a predetermined operation in a case where the other vehicle recognized is present within a predetermined area of the host vehicle; and
inhibit the predetermined operation to be performed by the on-vehicle apparatus in a case where it is determined that the host vehicle is turning in the specific situation.
